(19) United States
(12) Patent Application Publication
(10) Pub. No.: US 2014/0323281 A1
(43) Pub. Date: Oct. 30, 2014

(54) BAG MAKING MACHINE AND METHOD

(71) Applicants: Robin G. Thurgood, Marshall, MI (US); Brian C. Bowerman, Quincy, MI (US)

(72) Inventors: Robin G. Thurgood, Marshall, MI (US); Brian C. Bowerman, Quincy, MI (US)

(21) Appl. No.: 14/253,448

(22) Filed: Apr. 15, 2014

Related U.S. Application Data
(60) Provisional application No. 61/815,423, filed on Apr. 24, 2013.

(51) Int. Cl. B31B 19/10; B31B 19/60; B31B 19/14

(52) U.S. Cl. CPC B31B 19/10; B31B 19/14; B31B 19/60; B31B 2237/60
USPC 493/22; 493/239

(57) ABSTRACT

A bag making machine and method automatically produces bags upon demand by feeding, sealing and cutting a tubular film. The bag is fully released upon formation to allow the formed bag to be freely removed from the machine.

### TECHNICAL FIELD

This application relates generally to the field of bag making machines that form bags from tubular plastic film and, more specifically, to a machine that presents a formed bag for selective removal by packing personnel and responsively produces another bag upon such removal.

### BACKGROUND

In the field of manual packaging of items a packer (i.e., a person) selects a bag, inserts an item in the bag and places the bagged item at a location for subsequent handling or shipping. The packer then repeats the steps for another item using another bag. Where the items are of variable length (e.g., food items of variable length), the packer may have different bag sizes from which to choose. Alternatively, an automated machine may be used by the packer to produce bags on demand, with the machine having an operator adjustable mechanism by which bag length can be easily varied.

U.S. Pat. No. 5,618,252 discloses a bag making machine in which bag length can be adjusted. In one embodiment, the bag leaves the machine generally horizontally and is blown open to enable ready insertion of an item into the bag. In another embodiment, the bag forming apparatus retains each produced bag at a predetermined location from which the bag is removed by an operator, with such retention achieved by a means for suspending each produced bag in the predetermined location where the bag is retained without being opened until the bag is removed by the operator. Thus, one end of the bag is held to enable the bag to be suspended. However, holding the bag in a suspended manner can occasionally make the bag difficult for the operator to remove.

It would be desirable to provide a bag making machine and method that produces bags on demand, while at the same freeing each formed bag from any type of holding mechanism so that operator removal of the formed bag from the machine is better facilitated.

### SUMMARY

In one aspect, a bag forming machine includes a tubular film feed system for moving tubular film along a feed path of the machine. A tube seal and cut system is positioned along the feed path for selectively sealing and cutting the film to form a bag. A film diversion mechanism is movable between a first position in which tubular film fed along the feed path is allowed to pass through an exit opening of the machine, and a second position in which tubular film is blocked from continued progression out of the exit opening to thereby cause tubular film to move into an internal accumulation area of the machine. A controller is associated with the tubular film feed system, the tube cut and seal system and the film diversion mechanism to enable production of bags of different lengths. The controller is configured for carrying out a bag forming operation in which the tubular film feed system is operated to feed tubular film past the tube seal and cut system while the film diversion mechanism is in the first position so that an unsealed end of the tubular film will pass out of the exit opening to a certain location regardless of bag length being produced and thereafter the film diversion mechanism is operated to accumulate a remaining bag portion within the machine, thereby providing a consistent bag pick location regardless of bag length.

In another aspect, a bag forming machine includes a tubular film feed system for moving tubular film along a feed path of the machine. A tube seal and cut system is positioned along the feed path for selectively sealing and cutting the film to form a bag. A film diversion mechanism is movable between a first position in which tubular film fed along the feed path is allowed to pass through an exit opening of the machine, and a second position in which tubular film is blocked from continued progression out of the exit opening to thereby cause tubular film to move into an accumulation area.

The machine provides an advantageous bag forming method.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1a and 1b show perspective partial views of one embodiment of a bag forming machine;

FIG. 2 shows a side elevation of the machine of FIG. 2;

FIGS. 3-10 show side elevations of the machine of FIGS. 1 and 2, depicting the progressive steps of bag formation and release.

### DETAILED DESCRIPTION

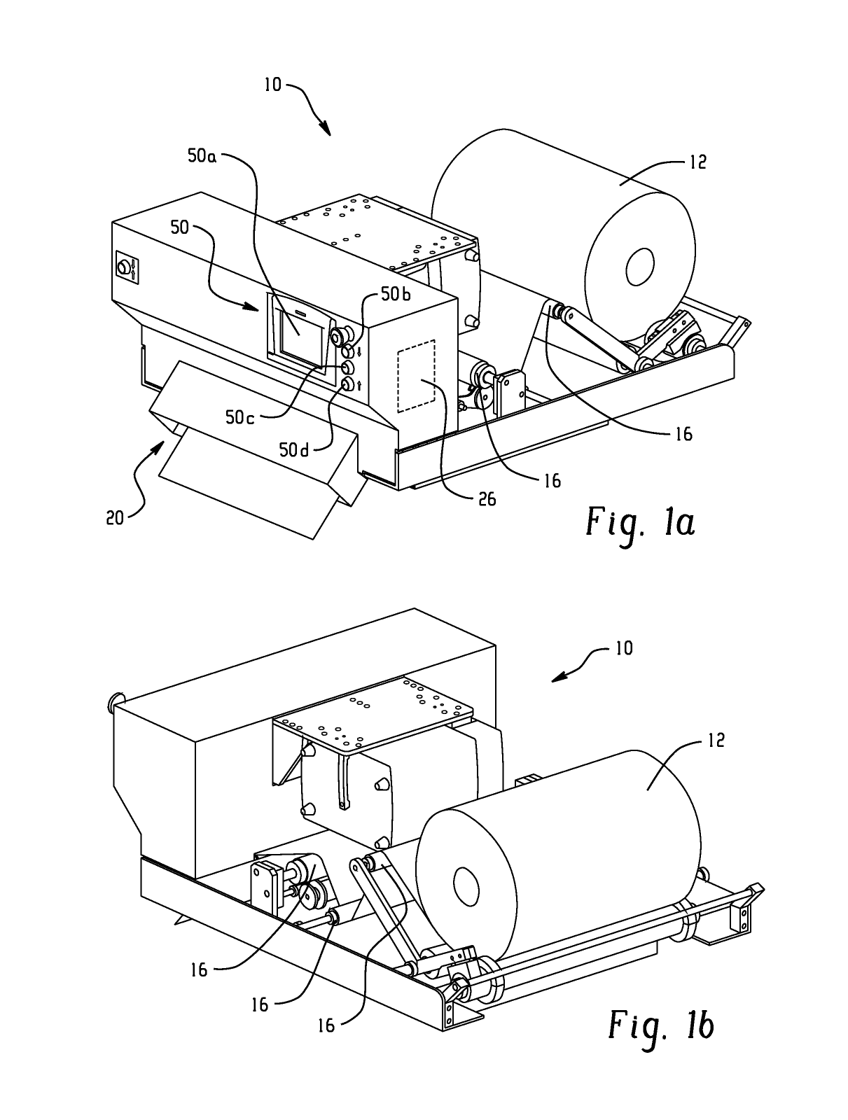

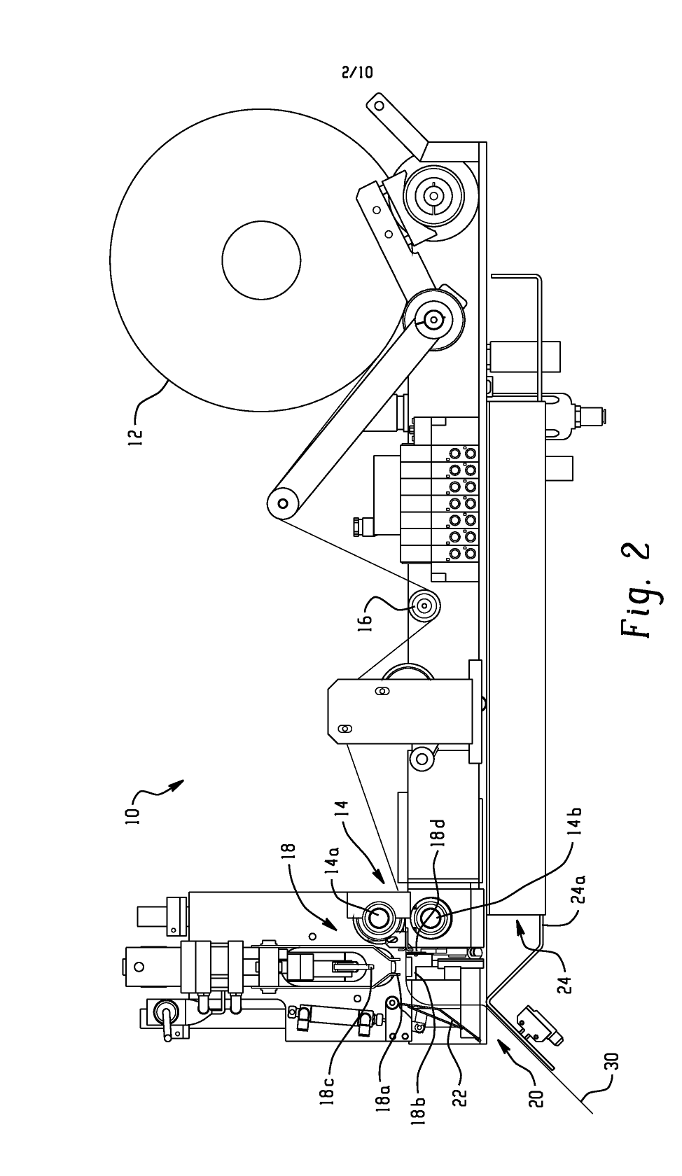

Referring to FIGS. 1 and 2, a bag forming machine 10 is shown. The machine 10 includes a film roll 12 loaded therein (e.g., a roll of tubular plastic film) and a tubular film feed system 14 (e.g., a set of rollers 14a and 14b forming a nip through which the film passes, with rotation of one or both of the rollers controlled by a servo motor or other drive arrangement) for moving tubular film along a feed path of the machine (e.g., from the roll location, around various rollers 16, past a tube seal and cut system 18 and to an exit opening 20 of the machine). The tube seal and cut system 18 is positioned along the feed path for selectively sealing and cutting the film to form a bag. In the illustrated embodiments the system 18 includes spaced apart film grip arms 18a that can be moved toward a film grip block 18b (e.g., to hold the film therebetween), a film seal mechanism 18c (e.g., a heated element) movable toward the film and a film cutter 18d (e.g, a knife) movable through the film path and film to cut the film. The film grip arms, seal mechanism and cutter may each be independently movable by suitable means such as a solenoid, motor or other device.

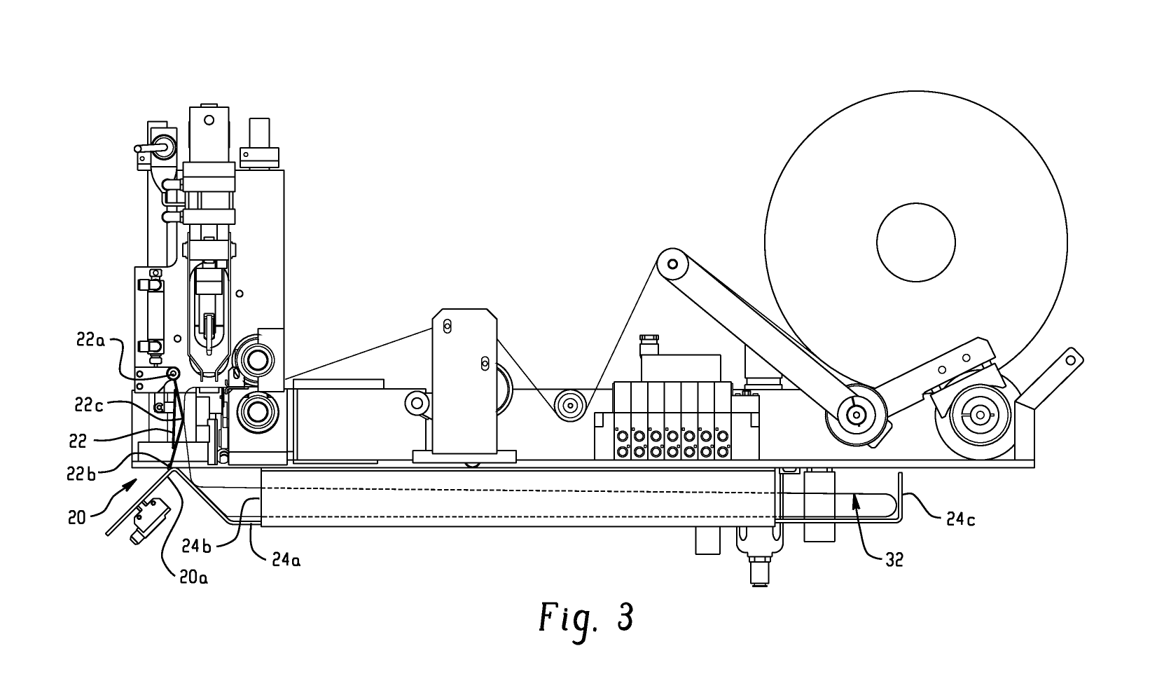

A film diversion mechanism 22 is located downstream of the tube cut and seal system 18 and is movable between the illustrated non-blocking position, in which tubular film fed along the feed path is allowed to pass through the exit opening of the machine, and a blocking position (see FIG. 3), in which tubular film is blocked from continued progression out of the exit opening to thereby cause tubular film to move into an internal accumulation area 24 of the machine.

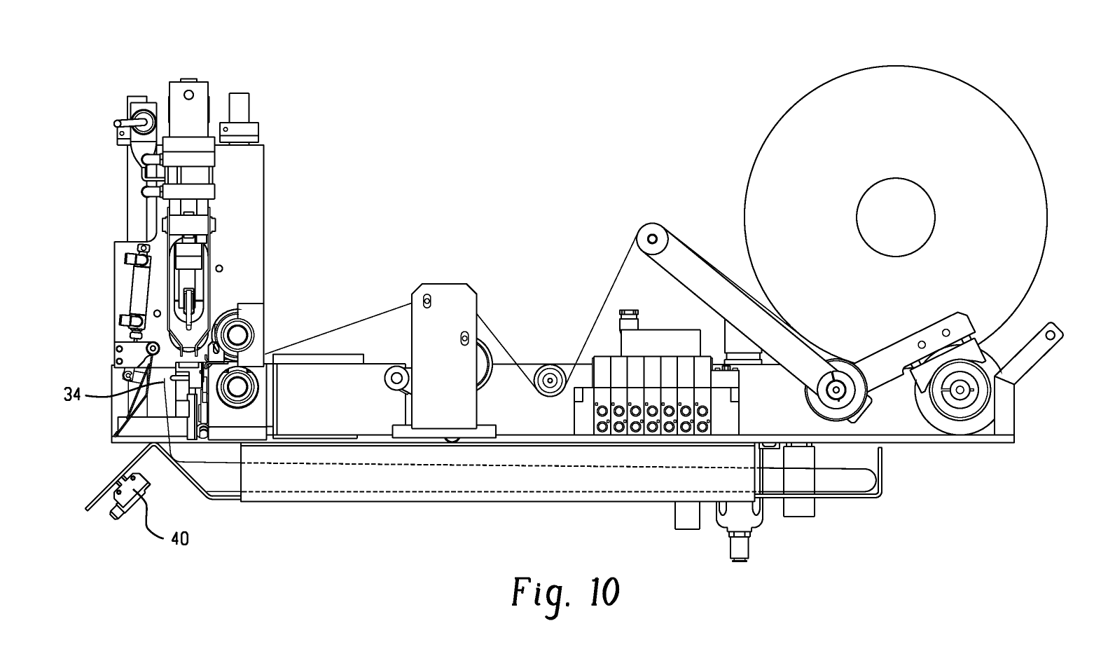

The machine includes a controller 26 (shown schematically in FIG. 1a) associated with each of the tubular film feed system 14, the tube seal and cut system 18 and the film diversion mechanism 22, and is configured for carrying out a bag forming operation, which will now be described with reference to FIGS. 2-10. Specifically, the tubular film feed system 14 is operated to feed tubular film past the tube seal and cut system 18 while the film diversion mechanism is in the non-blocking position of FIG. 2 so that an unsealed end 30 of the tubular film will pass out of the exit opening 20. After the unsealed end 30 of the tubular film reaches a certain location (e.g., the location of FIG. 2), the diversion mechanism 22 is moved to the blocking position shown in FIG. 3 while the tubular film feed system 14 is operated to move a length 32 (FIG. 3) of tubular film into the internal accumulation area 24 of the machine. In the illustrated embodiment, the internal accumulation area 24 is defined at least in part by a lateral tray 24a with sidewalls 24b and an end wall 24c, and the tubular film accumulates in loop form. Once the desired length of tubular film has been completely fed to form a bag of desired length (e.g., according to a set size as will be discussed below) operation of the tubular film feed system 14 is ceased in order to stop film feeding.

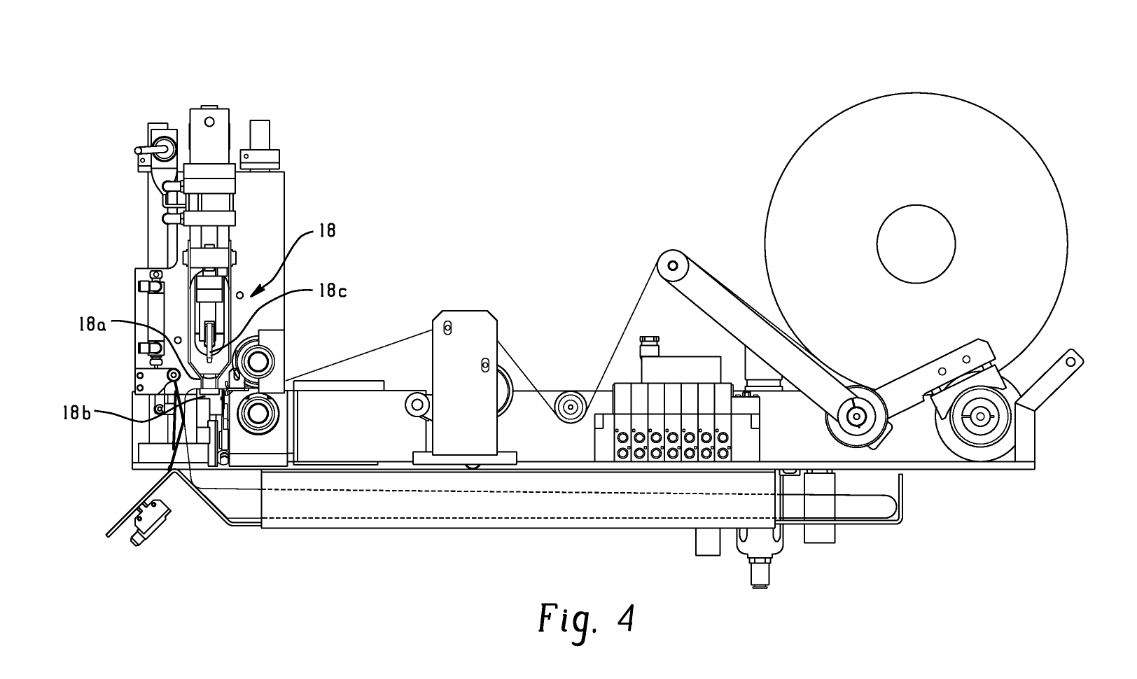

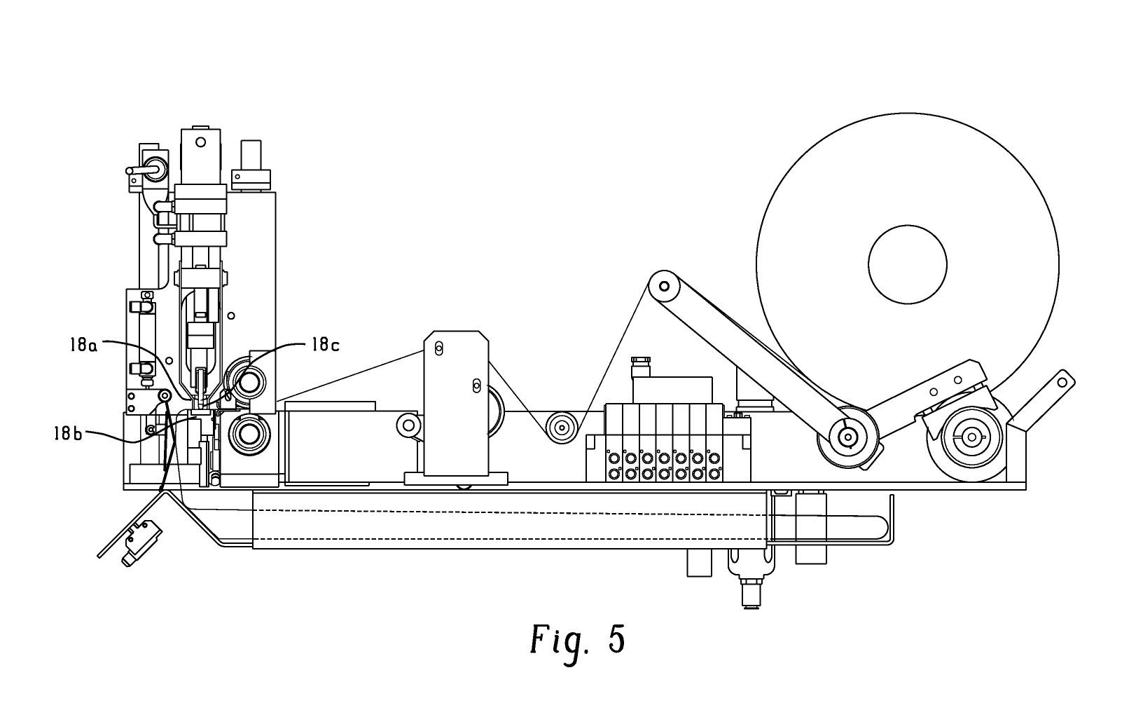

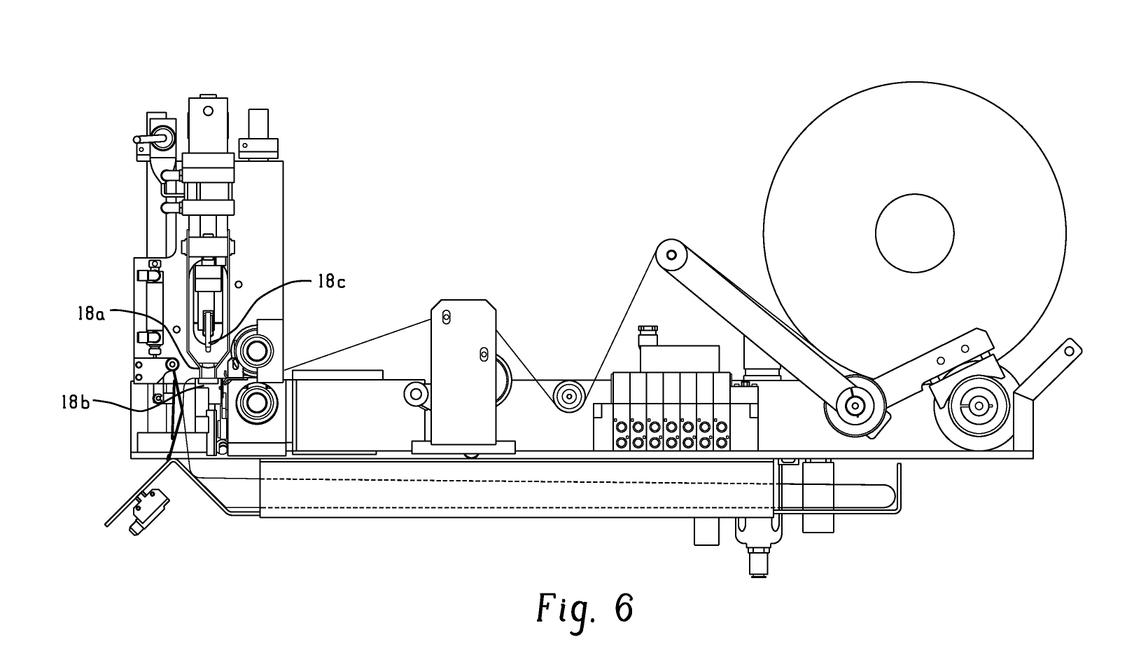

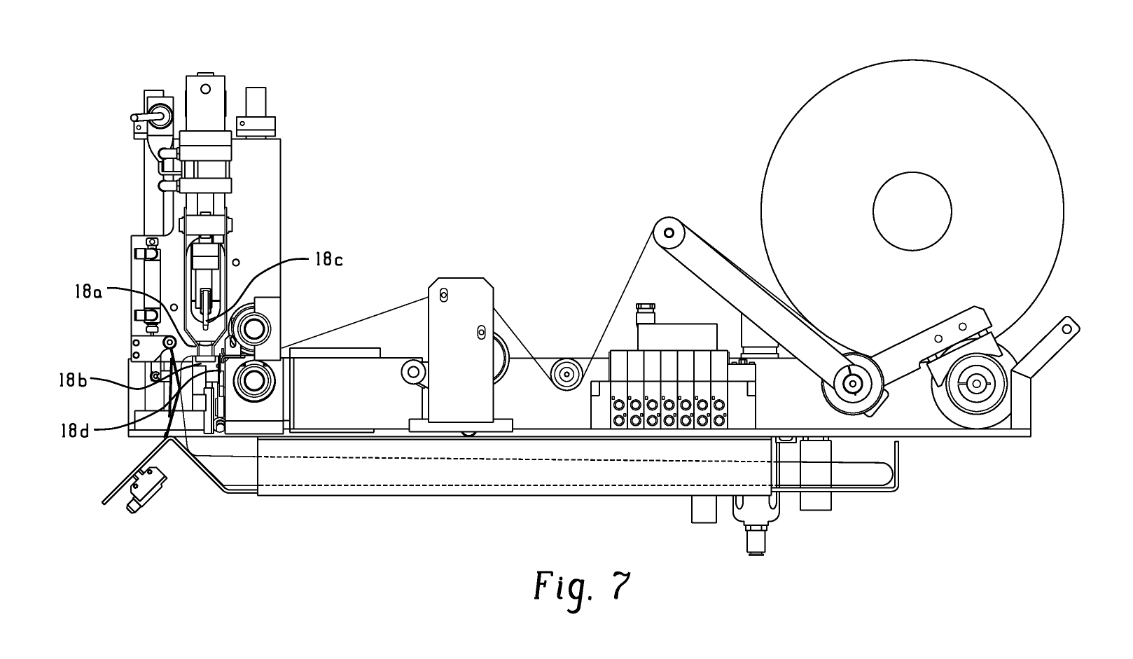

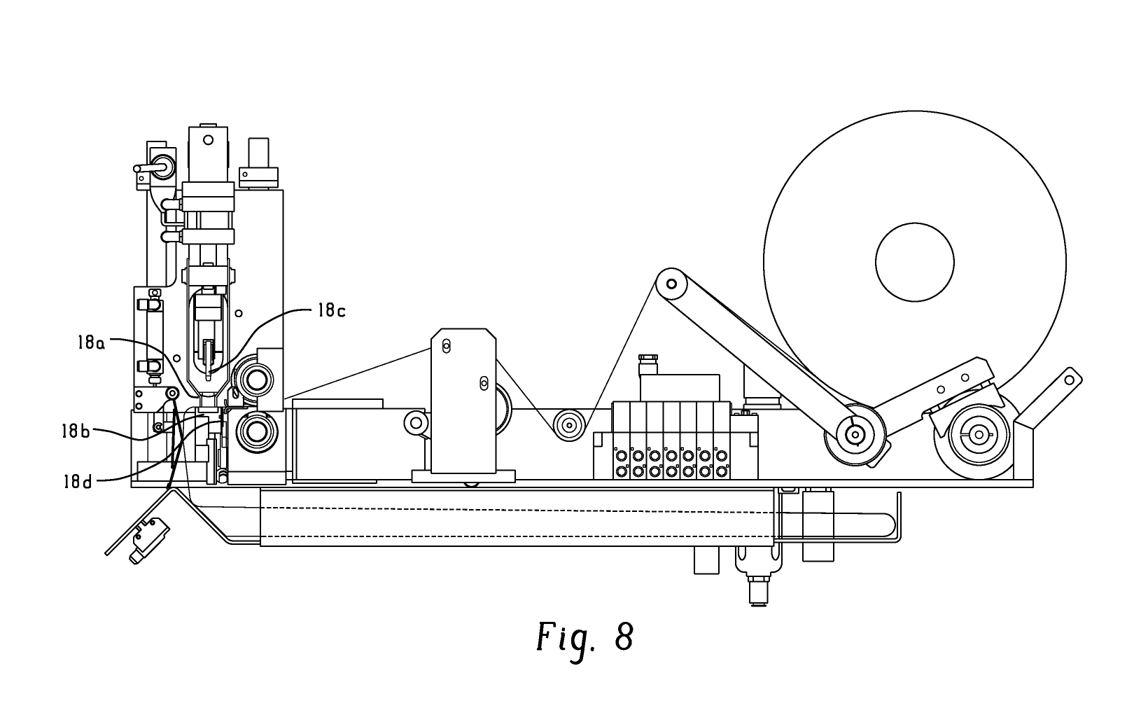

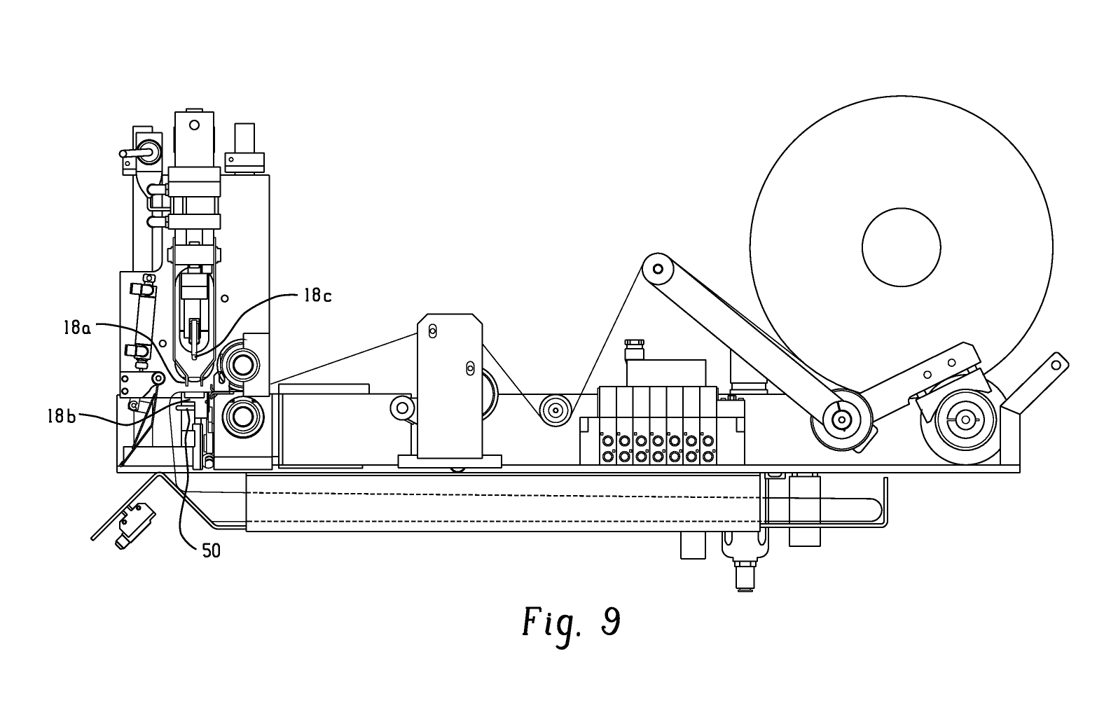

The tube seal and cut system 18 is then operated to form a bag by sealing and cutting an internal portion of the tubular film. In particular, and referring to FIGS. 4-10, once film feeding has stopped, the film grip arms 18a are moved down to tightly hold the film against the film block 18b, per FIG. 4. The film seal mechanism 18c is then moved into the film to create a seal, and subsequently retracted, per FIGS. 5 and 6. The film cutting mechanism 18d is then moved through the film (per FIG. 7) to completely sever the formed bag from the roll of tubular film, and is then retracted (per FIG. 8). The sealed end of the formed bag is released from the tube seal and cut system, as by retracting the film grip arms 18a per FIG. 9 and actively pushing the sealed end 34 of the bag away from the film grip by operation of a blower (shown schematically at 50 in FIG. 9). The film diversion mechanism 22 is also moved back toward the non-blocking position to allow the formed bag to be freely pulled out of the machine by an operator, whenever the operator chooses to grab the unsealed end of the bag and pull the bag from the machine. A weight of the loop within the machine is sufficient to prevent the formed bag from falling out of the exit opening. As an alternative to the blower mentioned above, a mechanical action could be used (e.g., a portion of the film diversion mechanism may be located and positioned to knock the end of the film down during movement back to the non-blocking position).

Notably, the unsealed end of the formed bag overlaps a film sensor 40, that detects removal of the formed bag. Upon such detection, the film sensor 40 automatically triggers repeat of the bag forming operation to produce another bag.

The illustrated diverting mechanism 22 is a pivoting member, with a pivot axis 22a (FIG. 3). A free end 22b of the pivoting member engages one portion of the tubular film (e.g., holding the film against a panel 20a of the exit opening 20) to block continued progression of the tubular film out of the exit opening. An intermediate portion 22c of the pivoting member interacts with an upstream portion of the tubular film to urge the tubular film toward the internal accumulation area 24.

The certain location to which the unsealed end of the film is moved (per FIG. 3) may be defined as a function of rotation of a motor associated with a tubular film feed arrangement of the machine (e.g., as a function of duration of rotation or as a function of number of rotations). In this regard, the bag forming machine can produce bags of different lengths, according to operator input settings. For example, a user interface 50 (FIG. 1a) of the machine includes a display 50a, and length setting buttons 50b, 50c and 50d. The controller 26, which may be part of the user interface 50, is preset with specific bag sizes for each of the buttons 50b, 50c and 50d, but those sizes can be modified via the user interface. Nonetheless, the buttons 50b, 50c and 50d provide an efficient means for the operator to change between multiple preset bag sizes. Additionally, the bag size may be adjusted in a fully variable manner (e.g., between a minimum size and a maximum) by using more advanced functionality of the interface 50. Moreover, the user interface 50 can be used to adjust the certain location to meet the needs of any given operator, or could be programmed to automatically define the certain location according to the operator using the machine (e.g., in the case of a machine that requires each operator to login with his/her unique identification).

Notably, in one implementation, regardless of the bag size being produced, the certain location to which the unsealed end of the film is fed is always the same, providing consistency for the user in terms of grasping the end of the formed bag.

Thus, a desirable bag forming method is provided, that involves the steps of: (a) feeding tubular film from a film roll past a tube seal and cut system of a machine; (b) during the feeding, (i) allowing an unsealed end of the tubular film to pass out of an exit opening of the machine; (ii) after the unsealed end of the tubular film reaches a certain location, operating a diverting mechanism to engage the tubular film to block continued progression of the tubular film out of the exit opening and to cause a length of tubular film to move into an internal accumulation area of the machine; (c) stopping the feeding and thereafter, (i) forming the tubular film into a bag by sealing and cutting an internal portion of the tubular film with the tube seal and cut system; (ii) releasing a sealed end of the formed bag from the tube seal and cut system; and (iii) operating the diverting mechanism to disengage the tubular film so as to allow an operator to freely pull the formed bag out of the machine.

In the illustrated embodiment, the releasing includes actively moving the sealed end of the formed bag away from the tube seal and cut system (e.g., achieved by an air blow operation), and the sealed end falls downward toward the accumulation area and/or exit opening upon release. However, in other variations the release need not include the active movement.

In the illustrated embodiment, the unsealed end of the formed bag overlaps a film sensor, and upon removal of the formed bag the film sensor automatically triggers repeat of steps (a), (b) and (c) to automatically produce another bag. However, other variations are possible.

In the illustrated embodiment, the length of tubular film accumulates in the form of a loop and the film accumulation area takes the form of a tray upon which the loop sits, and a weight of the loop is sufficient to prevent the formed bag from falling out of the exit opening. However, other variations are possible.

In the illustrated embodiment, the diverting mechanism is a pivoting member. A free end of the pivoting member engages one portion of the tubular film to block continued progression of the tubular film out of the exit opening and an intermediate portion of the pivoting member interacts with an upstream portion of the tubular film to urge the tubular film toward the internal accumulation area. However, other variations are possible.

In one implementation of the method, steps (c)(ii) and (c)(iii) take place substantially simultaneously. However, other variations are possible.

In one implementation of the method, the certain location is defined as a function of rotation of a motor associated with a tubular film feed arrangement of the machine. However, other variations are possible.

It is to be clearly understood that the above description is intended by way of illustration and example only, is not intended to be taken by way of limitation, and that other changes and modifications are possible.

What is claimed is:

1. A bag forming machine, comprising:
a tubular film feed system for moving tubular film along a feed path of the machine;
a tube seal and cut system positioned along the feed path for selectively sealing and cutting the film to form a bag; and
a film diversion mechanism movable between a first position in which tubular film fed along the feed path is allowed to pass through an exit opening of the machine, and a second position in which tubular film is blocked from continued progression out of the exit opening to thereby cause tubular film to move into an internal accumulation area of the machine;
a controller associated with the tubular film feed system, the tube cut and seal system and the film diversion mechanism to enable production of bags of different lengths;
the controller configured for carrying out a bag forming operation in which the tubular film feed system is operated to feed tubular film past the tube seal and cut system while the film diversion mechanism is in the first position so that an unsealed end of the tubular film will pass out of the exit opening to a certain location regardless of bag length being produced and thereafter the film diversion mechanism is operated to accumulate a remaining bag portion within the machine, thereby providing a consistent bag pick location regardless of bag length.

2. The bag forming machine of claim 1, further including a bag length adjustment input to the controller for enabling an operator to adjust bag length;

3. A method of producing a tubular bag, the method comprising:
(a) feeding tubular film from a film roll past a tube seal and cut system of a machine;
(b) during the feeding,
(i) allowing an unsealed end of the tubular film to pass out of an exit opening of the machine;
(ii) after the unsealed end of the tubular film reaches a certain location, operating a diverting mechanism to engage the tubular film to block continued progression of the tubular film out of the exit opening and to cause a length of tubular film to move into an internal accumulation area of the machine;
(c) stopping the feeding and thereafter,
(i) forming the tubular film into a bag by sealing and cutting an internal portion of the tubular film with the tube seal and cut system;
(ii) releasing a sealed end of the formed bag from the tube seal and cut system; and
(iii) operating the diverting mechanism to disengage the tubular film so as to allow an operator to freely pull the formed bag out of the machine.

4. The method of claim 3 wherein the releasing includes actively moving the sealed end of the formed bag away from the tube seal and cut system.

5. The method of claim 4 wherein the active movement is achieved by an air blow operation.

6. The method of claim 4 wherein the sealed end falls downward toward the accumulation area and/or exit opening upon release.

7. The method of claim 3 wherein the unsealed end of the formed bag overlaps a film sensor, upon removal of the formed bag the film sensor automatically triggers repeat of steps (a), (b) and (c) to automatically produce another bag.

8. The method of claim 3 wherein the length of tubular film accumulates in the form of a loop and the film accumulation area takes the form of a tray upon which the loop sits.

9. The method of claim 8 wherein a weight of the loop is sufficient to prevent the formed bag from falling out of the exit opening.

10. The method of claim 3 wherein the diverting mechanism is a pivoting member, a free end of the pivoting member engages one portion of the tubular film to block continued progression of the tubular film out of the exit opening and an intermediate portion of the pivoting member interacts with an upstream portion of the tubular film to urge the tubular film toward the internal accumulation area.

11. The method of claim 3 wherein steps (c)(ii) and (c)(iii) take place substantially simultaneously.

12. The method of claim 3 wherein the certain location is defined as a function of rotation of a motor associated with a tubular film feed arrangement of the machine.

13. A method of producing first and second bags of different lengths, the method comprising:
carrying out the method of claim 3 to produce a tubular bag having a first length, wherein the length of tubular film that moves into the internal accumulation area is a first accumulation length;
adjusting the machine to define a second bag length; and
carrying out the following steps after the adjusting step:
(a2) feeding tubular film from the film roll past the tube seal and cut system of the machine;
(b2) during the feeding of step (a2),
(i) allowing an unsealed end of the tubular film to pass out of the exit opening of the machine;
(ii) after the unsealed end of the tubular film reaches the certain location, operating the diverting mechanism to engage the tubular film to block continued progression of the tubular film out of the exit opening and to cause a second accumulation length of tubular film to move into the internal accumulation area of the machine, wherein the second accumulation length is different than the first accumulation length;
(c2) stopping the feeding of step (a2) and thereafter,
(i) forming the tubular film into a bag by sealing and cutting an internal portion of the tubular film with the tube seal and cut system;
(ii) releasing a sealed end of the formed bag from the tube seal and cut system; and
(iii) operating the diverting mechanism to disengage the tubular film so as to allow an operator to freely pull the formed bag out of the machine.

14. A bag forming machine, comprising:
a tubular film feed system for moving tubular film along a feed path of the machine;
a tube seal and cut system positioned along the feed path for selectively sealing and cutting the film to form a bag; and
a film diversion mechanism movable between a first position in which tubular film fed along the feed path is allowed to pass through an exit opening of the machine, and a second position in which tubular film is blocked from continued progression out of the exit opening to thereby cause tubular film to move into an internal accumulation area of the machine.

15. The bag forming machine of claim 14, further comprising:
a controller associated with the tubular film feed system, the tube seal and cut system and the film diversion mechanism and configured for carrying out a bag forming operation in which:
the tubular film feed system is operated to feed tubular film past the tube seal and cut system while the film diversion mechanism is in the first position so that an unsealed end of the tubular film will pass out of the exit opening;
after the unsealed end of the tubular film reaches a certain location, the diversion mechanism is moved to the second position while the tubular film feed system is operated to move a length of tubular film into the internal accumulation area of the machine;
operation of the tubular film feed system is ceased to stop film feeding;
the tube seal and cut system is operated to form a bag by sealing and cutting an internal portion of the tubular film;
a sealed end of the formed bag is released from the tube seal and cut system; and
the film diversion mechanism is moved back toward the first position to allow the formed bag to be freely pulled out of the machine.

16. The machine of claim 15, further comprising:
an air blow mechanism positioned proximate the tube seal and cut system to move the sealed end of the formed bag away from the tube seal and cut system.

17. The machine of claim 15, further comprising:
a sensor positioned to detect the unsealed end of the formed bag and operable upon removal of the formed bag to trigger the controller to automatically cause the machine to produce another bag.

18. The machine of claim 15 wherein the film accumulation area takes the form of a tray and the length of tubular film sits in the form of a loop.

19. The machine of claim 15 wherein the film diversion mechanism is a pivoting member, when the film diversion mechanism is in the second position a free end of the pivoting member engages one portion of the tubular film.

20. The machine of claim 14, further comprising:
a controller associated with the tubular film feed system, the tube cut and seal system and the film diversion mechanism;
a bag length adjustment input to the controller for enabling an operator to adjust bag length;
the controller configured for carrying out a bag forming operation in which:
the tubular film feed system is operated to feed tubular film past the tube seal and cut system while the film diversion mechanism is in the first position so that an unsealed end of the tubular film will pass out of the exit opening to a certain location regardless of bag length being produced;
after the unsealed end of the tubular film reaches the certain location, the diversion mechanism is moved to the second position while the tubular film feed system is operated to move a length of tubular film into the internal accumulation area of the machine.

21. The machine of claim 20 wherein the controller is further configured such that in the bag forming operation:
operation of the tubular film feed system is ceased to stop film feeding;
the tube seal and cut system is operated to form a bag by sealing and cutting an internal portion of the tubular film;
a sealed end of the formed bag is released from the tube seal and cut system; and
the film diversion mechanism is moved back toward the first position to allow the formed bag to be freely pulled out of the machine.
